(19) United States
(12) Patent Application Publication
(10) Pub. No.: US 2015/0122148 A1
(43) Pub. Date: May 7, 2015

(54) ASPHALT CONCRETE WITH MODIFIED OIL FLY ASH

(71) Applicants: KING ABDULAZIZ CITY FOR SCIENCE AND TECHONOLOGY, RIYADH (SA); KING FAHD UNIVERSITY OF PETROLEUM AND MINERALS, DHAHRAN (SA)

(72) Inventors: HAMAD IBRAHIM AL-ABDUL WAHHAB, DHAHRAN (SA); MOHAMMAD ANWAR PARVEZ, DHAHRAN (SA); IBNELWALEED ALI HUSSEIN, DHAHRAN (SA); REYAD AWWAD SHAWABKEH, DHAHRAN (SA)

(73) Assignees: KING ABDULAZIZ CITY FOR SCIENCE AND TECHONOLOGY, RIYADH (SA); KING FAHD UNIVERSITY OF PETROLEUM AND MINERALS, DHAHRAN (SA)

(21) Appl. No.: 14/072,768

(22) Filed: Nov. 5, 2013

(51) Int. Cl. C08L 95/00; C08K 5/09

(52) U.S. Cl. CPC C08L 95/00; C08K 5/09; C08L 2555/52
USPC 106/281.1; 554/71

(57) ABSTRACT

The asphalt with modified oil fly ash additive provides an improved asphalt binder for asphalt concrete. In one embodiment, the oil fly ash is modified to include a carboxylic acid group (—COOH) attached to the surface of the oil fly ash. In another embodiment, the oil fly ash is modified to attach 1-octadecanoate to the surface of the oil fly ash. The modified oil fly ash additive may be mixed with the asphalt cement or binder material, or mixed with the aggregate material for incorporation into asphalt concrete. The asphalt with modified oil fly ash additive improves the performance grade of asphalt binder from 64-10 to 82-10, eliminates the need for the usual commercial polymer modifier, improves the rutting resistance of asphalt concrete mixes over unmodified oil fly ash, and provides for an environmentally friendly way of disposing of oil fly ash waste.

### BACKGROUND OF THE INVENTION

1. Field of the Invention

The present invention relates to paving materials, and particularly to asphalt with modified oil fly ash additive that provides an improved performance grade asphalt cement or binder.

2. Description of the Related Art

Asphalt concrete, also referred to as simply “asphalt” or “blacktop”, is a commonly used material in the construction industry. Construction projects that implement asphalt concrete include roads, highways, parking lots, airports, and embankment dams, for example. Asphalt concrete comprises an aggregate material and a binder material. The aggregate material is usually some type of mineral, such as sand, basalt rock, or limestone, among others. The binder material generally comprises asphalt cement, with or without additives to improve its performance characteristics. The aggregate and binder materials are mixed together and then compacted to produce asphalt concrete.

Plain and modified forms of asphalt concrete may have disadvantages in certain applications because of performance characteristics, such as surface durability. Plain and modified forms of asphalt concrete may deform or fail in situations where vehicular traffic is significant, or vehicular weight is large, or where weather such as snow or excessive heat, is present. If the surface of the asphalt concrete begins to wear down, several issues, such as tire damage to vehicles caused by cracks or crevices in the asphalt concrete or road closures for repairs, could begin to occur as the asphalt concrete begins to wear. Thus, new additives that may improve the performance of asphalt binders are constantly being sought.

Currently, in Saudi Arabia, various polymers are added to the asphalt cement to help improve the properties of the asphalt. Sulfur is often added as a cross-linking agent to improve polymer performance. At the same time, a large quantity of oil fly ash is produced by the use of heavy fuel oil combustion for power generation. The large quantity of oil fly ash produced annually presents problems for disposing of the oil fly ash as waste in an environmentally friendly manner.

Thus, asphalt with modified oil fly ash additive solving the aforementioned problems is desired.

### SUMMARY OF THE INVENTION

The asphalt with modified oil fly ash additive provides an improved asphalt binder for asphalt concrete. In one embodiment, the oil fly ash is modified to include a carboxylic acid group (—COOH) attached to the surface of the oil fly ash. In another embodiment, the oil fly ash is modified to attach 1-octadecanoate to the surface of the oil fly ash. The modified oil fly ash additive may be mixed with the asphalt cement or binder material, or mixed with the aggregate material for incorporation into asphalt concrete. The asphalt with modified oil fly ash additive improves the performance grade of asphalt binder from 64-10 to 82-10, eliminates the need for the usual commercial polymer modifier, improves the rutting resistance of asphalt concrete mixes over unmodified oil fly ash, and provides for an environmentally friendly way of disposing of oil fly ash waste.

These and other features of the present invention will become readily apparent upon further review of the following specification and drawings.

### BRIEF DESCRIPTION OF THE DRAWINGS

FIG. 1 is a chart showing a comparison of rutting test results of asphalt with modified oil fly ash additive according to the present invention with various forms of unmodified and modified asphalt.

FIG. 2 is a chart of fatigue of asphalt with modified oil fly ash additive according to the present invention compared with various forms of unmodified and modified asphalt.

Similar reference characters denote corresponding features consistently throughout the attached drawings.

### DETAILED DESCRIPTION OF THE PREFERRED EMBODIMENTS

The asphalt with modified oil fly ash additive provides an improved asphalt binder for asphalt concrete. In one embodiment, the oil fly ash is modified to include a carboxylic acid group (—COOH) attached to the surface of the oil fly ash. In another embodiment, the oil fly ash is modified to attach 1-octadecanoate to the surface of the oil fly ash. The modified oil fly ash additive may be mixed with the asphalt cement or binder material, or mixed with the aggregate material for incorporation into asphalt concrete. The asphalt with modified oil fly ash additive improves the performance grade of asphalt binder from 64-10 to 82-10, eliminates the need for the usual commercial polymer modifier, improves the rutting resistance of asphalt concrete mixes over unmodified oil fly ash, and provides for an environmentally friendly way of disposing of oil fly ash waste.

Preliminarily, the terms “asphalt” and “asphalt cement” refer to a dark brown to black cementitious material composed of bitumens that occur in nature or are obtained in petroleum refining processes. The term “asphalt binder” refers to asphalt cement that is classified according to the Standard Specification for Performance Graded Asphalt Binder, AASHTO Designation MP1. A binder can be unmodified or modified in accordance with the specification. “Performance Grade” refers to an asphalt binder grade designation used in Superpave® (Superpave is a registered trademark of the National Academy of Sciences. Washington, D.C.) based on the binder's mechanical performance at critical temperatures and aging conditions. There is some overlap, so that “asphalt”, “asphalt cement”, and asphalt binder” are sometimes used interchangeably. “Asphalt concrete” refers to a mixture of asphalt binder, aggregate, and air compacted into a mass. Asphalt concrete may also include a “filler”, usually a mineral filler, that is used to fill the voids between the asphalt and the aggregate. Fillers may be silica (usually sand), limestone dust, Portland cement, fly ash, or other fine material.

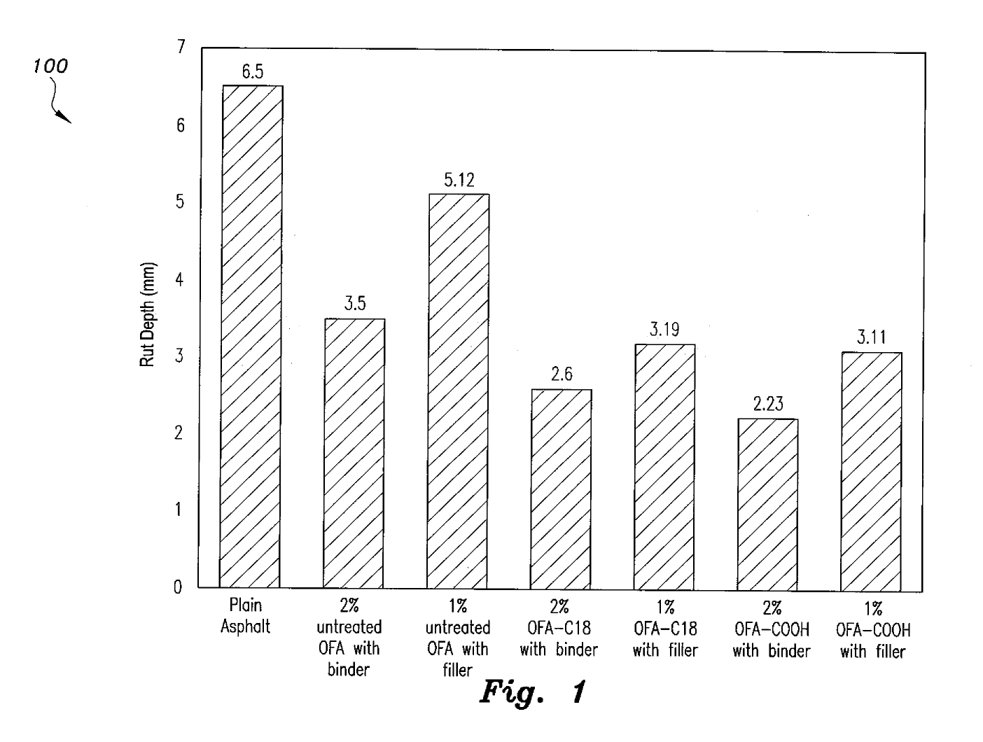

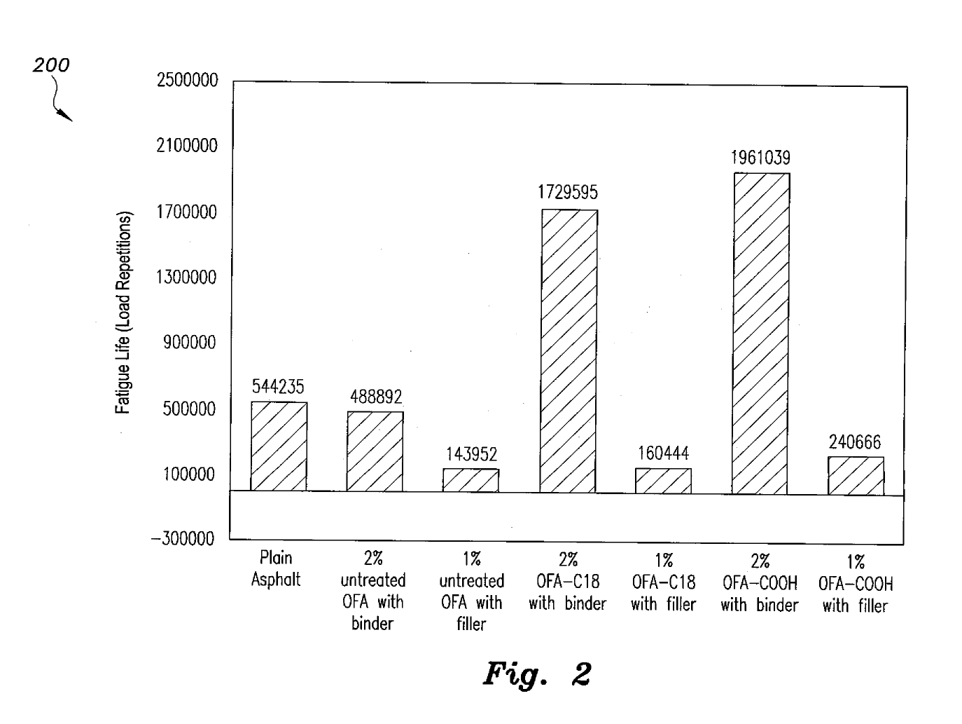

Oil fly ash (OFA) is a waste by-product of a crude oil refining process containing around 80% carbon and may be characterized by its low specific gravity, which is a function of its chemical composition. The specific gravity of OFA may vary in between a range of about 2.3 to about 2.6, with an average specific gravity of about 2.4. The typical OFA particle size is generally in the range of about 0.5 micrometers (μm) to about 100 μm. However, particle size distribution generally depends on the type of collector that is used to collect the OFA during the crude oil refining process. For the experimental data measurements 100 and 200 shown in FIGS. 1 and 2, respectively, the OFA material used in the compositions of the asphalt concrete embodiments was collected from the Shoaiba power and desalination plant located in Saudi Arabia along the coast of the Red Sea. Electrostatic precipitators installed on boilers that were burning residual oil from the refining process for air pollution control collected the OFA material. The elemental composition of the OFA collected by these electrostatic precipitators at the Shoaiba plant was about 84% carbon, 6% sulfur, and 5% oxygen, with the remaining amount being small amounts of trace metals.

The modification of the OFA included several steps of chemical treatment, mainly done in three phases. The three phases were a prewash phase, an acid treatment phase, and a final wash phase. One of the objectives behind the prewash phase was to remove oily residue and sandy particles from the raw OFA. Oily residue and sandy particles typically lower the performance grade of asphalt binder, since they can reduce the viscosity of an OFA/asphalt cement mixture. The raw OFA was washed with water at about room temperature using a Buchner funnel with a sintered glass disc. The sandy particles were separated from the bottom and the oily residue was separated from the top. The remaining filtered OFA was then dried in a dry chamber at a temperature of about 105° C. for a time period of about 12 hours to allow for evaporation of any remaining water from the filtered OFA.

During the following acid treatment phase, sulfuric acid (H₂SO₄) of about 98% concentration and nitric acid (HNO₃) of about 69% concentration were used to functionalize the OFA. About 600 milliliters (ml) of the sulfuric acid and about 200 ml of the nitric acid were mixed together at room temperature for a volumetric ratio of 3:1. The sulfuric/nitric acid mixture was then stirred for about 10 minutes to complete the mixing of the acids together to form an acid solution. About 200 grams (g) of the dried OFA was placed into a 3 liters (L) glass beaker, and the acid solution was slowly poured into the dried ash. After 10 minutes, the mixture turned to liquid solution and was placed on a hot plate with a stirrer at a temperature of 165° C. for 12 hours. The stirring speed for stirring the heated acid OFA mixture was set to 100 revolutions per minute (rpm) to allow for a homogeneous temperature of the solution. The reaction was allowed to continue for 12 hours to create the carboxylic acid group on the OFA surface. After 12 hours, the liquid solution was cooled down to about room temperature to be ready for final wash.

In the remaining final wash phase, the cooled liquid solution was diluted with about 6 liters of deionized water. The temperature after reaction was about 100° C. After dilution with the deionized water, the solution was cooled to a temperature of about 50° C. The diluted cooled solution was then vacuum-filtered through 3 micrometers (m) porosity filter paper by the same procedure performed in the prewash phase to remove any remaining unreacted acid. The filter cake of the ash was then put in a glass beaker and dried in a hot chamber at a temperature of about 90° C. for about 12 hours to complete drying. The oil fly ash treated in this manner is referred to herein as OFA-COOH. Chemically treating the OFA with this process allowed for a carboxyl acid group to be attached to the surface of the OFA, thus resulting in OFA-COOH.

A portion of the OFA-COOH was further treated to add an octadecanoyl group to the modified oil fly ash by Fischer esterification with 1-octadecanol. The modified OFA produced by this further treatment is referred to herein as OFA-C₁₈. The net result is that a 1-octadecanoate group was attached to the surface of the OFA.

The OFA-C18 was synthesized as follows. OFA as-received was washed with water to separate trace oil and some sandy particles. Washed OFA was then dried in oven at 105° C. to evaporate the remaining water. The OFA was then treated with H₂SO₄ and HNO₃ at a volumetric ratio of 3:1. A weight of 200 g ash was taken into a 3-liter glass beaker, and the acid solution was slowly poured into the ash. After 10 minutes, the ash/acid mixture turned to liquid solution. The beaker with OFA/acid solution was put on a hot plate/magnetic stirrer assembly. The temperature and speed of rotation of the hot plate were set at 165° C. and 100 rpm, respectively. The reaction was allowed to continue for 12 hours to create the carboxylic acid group on the OFA surface. The reaction mixture was then cooled to room temperature. The mixture was diluted with deionized water and filtered using vacuum-filtration through a 3 μm porosity filter paper to remove unreacted acid. The filtered OFA was then dried in a hot chamber at a temperature of ˜90° C. The treated OFA by this method is referred to as OFA-COOH.

OFA-COOH was then reacted with 1-octadecanol (C₁₈H₃₈O), which is referred to as C₁₈. Its melting point is 59° C., with 95% purity. The Fischer esterification process was followed to substitute 1-octadecanol for the acid group. This was achieved by heating 1-octadecanol to its melting point in a reaction flask and maintaining the temperature at 90° C. Acid-treated OFA (OFA-COOH) was introduced into the reaction flask containing 1-octadecanol in a weight ratio of 1:3. The mixture was stirred 10 minutes, and then 2 ml of sulfuric acid was added gradually to initiate the following esterification reaction:

OFA-COOH+CH₃(CH₂)₁₇OH→OFA-COO(CH₂)₁₇CH₃+H₂O↑.

The Fischer esterification reaction is an equilibrium reaction. To shift the equilibrium to favor the production of esters, it is customary to use an excess of one of the reactants, either the alcohol or the acid. So, an excess amount of 1-octadecanol was used to favor OFA-C₁₈ production. Another way to drive a reaction toward its products is to remove one of the products as it forms. Water formed in this reaction was removed by evaporation during the reaction. The reaction was left for 6 hours, after which the resulting ash was washed with toluene three times to remove any unreacted 1-octadecanol, and then followed by washing with deionized water to remove any traces of acid. OFA-C₁₈ modified OFA was dried at 60° C. under vacuum for 12 hours and was ready to be mixed with asphalt.

Both embodiments of the modified oil fly ash were analyzed by Scanning Electron Microscopy (SEM) and Energy Dispersive X-ray analysis (EDS). It was apparent from the SEM/EDS analysis that most of the ash particles were spherical in shape with high porosity. The size of these particles was in the range of 10-100 μm. The combined SEM/EDS analysis provided an elemental analysis, with the results shown below in Table 1, from which the ratio of carbon, oxygen, and sulfur could be determined.

TABLE 1
Elemental analysis of OFA before and after treatment

| | | Before Treatment | | OFA-COOH | | OFA-C₁₈ | |
|---|---|---|---|---|---|---|---|
| Selec- | Ele- | Weight | Atomic | Weight | Atomic | Weight | Atomic |
| tion | ment | % | % | % | % | % | % |
| 1 | C | 79.99 | 89.40 | 67.58 | 77.75 | 73.54 | 79.35 |
| 2 | O | 7.02 | 5.89 | 19.15 | 16.54 | 24.53 | 19.87 |
| 3 | S | 8.74 | 3.66 | 13.16 | 5.72 | 1.93 | 0.78 |
| 4 | V | 1.83 | 0.48 | 0 | 0 | 0 | 0 |
| 5 | Fe | 1.07 | 0.26 | 0 | 0 | 0 | 0 |
| 6 | Ni | 1.36 | 0.31 | 0 | 0 | 0 | 0 |
| Total | | 100 | 100 | 100 | 100 | 100 | 100 |

The carbon-to-oxygen ratio in these samples illustrates the degree of oxidation before and after treatment. The oxygen-to-carbon ratio has changed as a result of the acid treatment. The ratio of oxygen to carbon weight percentages in the oil fly ash before treatment was about 0.087. However, the ratio of oxygen to carbon weight percentages for OFA-COOH was about 0.283, and for OFA-C₁₈ was about 0.333. This increased ratio is attributed to the addition of the —COOH functional group to the OFA surface. Another finding shown in Table 1 is that the acid treatment phase substantially removed undesired metals, such as vanadium (V), iron (Fe), and nickel (Ni), from the OFA. Further, the acid treatment phase also increased the ratio of sulfur to carbon. This may be explained by the formation of CO₂ and CO gases. These gases can escape from the oil fly ash sample, which can decrease the amount of carbon and thus increase the amount of sulfur.

After the OFA was chemically treated and modified into either OFA-COOH or OFA-C₁₈, the modified OFA was then used in a process to produce performance grade asphalt binder. A special high-shear blender was used to blend OFA with the asphalt cement. The blending speed was controlled with a DC motor capable of producing up to 2500 rpm. The temperature was controlled through a hot oil bath. Blending time was fixed to 10 minutes at 130° C. Treated OFA-modified asphalt binder with different percentages of OFA content were performance graded according to the Strategic Highway Research Program (SHRP, AASHTO M320-09). Table 2 summarizes the results of the performance grade (PG) tests.

TABLE 2
Performance Grade of treated OFA asphalt binders

| | | PG of unmodified | PG of OFA- | PG of OFA- |
|---|---|---|---|---|
| Sample | % OFA | OFA | COOH | C₁₈ |
| 1 | 0 | 64-10 | 64-10 | 64-10 |
| 2 | 2 | 70-10 | 76-10 | 70-10 |
| 3 | 4 | 70-10 | 76-10 | 76-10 |
| 4 | 6 | 70-10 | 82-10 | 76-10 |
| 5 | 8 | 70-10 | 82-10 | 82-10 |

The Superpave mix design method was used to design asphalt concrete mixes following the Saudi Ministry of Transport (MOT) specifications for typical Superpave wearing course layer and modified asphalt binder. The optimum asphalt content obtained through the Superpave mix design method for different additive-asphalt combinations was used to prepare compacted beam samples of about 38 centimeters (cm)×6.6 cm×5.0 cm utilizing a slab compactor and two cylindrical samples of different size, one about 10 cm in diameter and one about 15 cm in diameter, utilizing a gyratory compactor.

OFA was blended with asphalt cement binder using the high shear blender. OFA was added to asphalt at a rate of 2%, 4%, 6%, and 8% of the total binder mass and blended with the asphalt cement at 130° C. for 10 minutes. Plain and modified asphalts were mixed with aggregate at 145° C., at which the binder viscosity is 0.170±0.02 Pa·s, in a large temperature-controlled mixer and compacted in either a 10 cm or 15 cm mold, depending upon the intended test type, using the gyratory compactor. The compaction temperature was set at 130° C., at which the binder has a viscosity of 0.280±0.03 Pa·s.

In an alternative mixing procedure, the OFA samples were added to the aggregate material as at least partial filler replacement at rates of 1, 2, and 3% of the total aggregate mass, and blended with the aggregate for at least 10 seconds before adding the asphalt. The aggregate materials used to create the samples were coarse and fine aggregates collected from a local limestone quarry. Limestone is the dominant type of aggregate used for road construction in the Eastern and Central Regions of the Kingdom of Saudi Arabia. Crushed aggregates were selected from Ministry of Transport (MOT) approved crushers that are currently supplying crushed aggregates to road projects. The aggregates were selected to meet MOT aggregate specifications. The aggregates were sifted through meshes of progressively smaller mesh size. The gradation of the aggregate size is given below in Table. 3.

TABLE 3
Gradation of aggregate

| Sieve Size, mm | % Passing |
|---|---|
| 12.5 | 95.2 |
| 9.5 | 81.8 |
| 4.75 | 44.0 |
| 2.36 | 34 |
| 0.075 | 5.0 |

The samples had a mass ratio of about 5% asphalt binder and about 95% aggregate.

Several tests were performed on the various asphalt concrete samples. An Indirect Tensile Strength (ITS) test according to AASHTO T 245 guidelines was performed to determine mix resistance to the development of cracks. The ITS tests were performed on cylindrical specimens having a height of 63.5 mm and a diameter of 101.6 mm (2.5 inches height and 4 inches diameter). The samples were compacted to the optimum density by using the Superpave gyratory compaction method. The ITS tests determined the maximum load a sample could carry before failure. The ITS tests were carried out at 25° C. The results of the tested specimens are presented below in Table 4.

TABLE 4
ITS test results for different asphalt concrete mixes

| | | Mean ITS, kPa | | |
|---|---|---|---|---|
| | | Untreated | Treated OFA- | Treated OFA- |
| Mix Type | % OFA | OFA | COOH | C₁₈ |
| Plain Mix | 0 | | 897 | |
| OFA-Modified | 2 | 1115 | 1194 | 968 |
| Binder | 4 | 1010 | 1070 | 880 |
| | 6 | 1015 | 1092 | 823 |
| | 8 | 1021 | 1118 | 785 |
| OFA-Replaced | 1 | 919 | 1170 | 923 |
| Filler | 2 | 744 | 886 | 662 |
| | 3 | 440 | 864 | 628 |

As shown in Table 4, the asphalt concrete samples with the OFA-COOH modified binders provided around 10-15% higher mean ITS values in kilopascals (kPa) compared to plain, untreated mix. In the case of filler replacement, treated oil fly ash is far better than untreated oil fly ash.

A second test performed on the asphalt concrete samples was a resilient modulus test that measures pavement response in terms of dynamic stresses and corresponding resulting strains according to ASTM D 4123 specifications. Resilient modulus testing of hot mix asphalt (HMA) samples was conducted by applying diametral pulse loads to the samples. The loads were applied in the vertical diametrical plane of cylindrical samples having a height of 63.5 mm and diameter of 101.6 mm (2.5 inches height and 4 inches diameter). The samples were compacted to the optimum density using the Superpave gyratory compaction method. The resulting horizontal deformation of the samples was measured and used to calculate the resilient modulus. The resilient modulus test results are shown below in Table 5.

TABLE 5
Resilient Modulus test results for different mixes

| | | Mean M_{R}, MPa | | |
|---|---|---|---|---|
| | % | | Treated | Treated |
| Mix Type | OFA | Untreated OFA | OFA-COOH | OFA-C₁₈ |
| Plain Mix | 0 | 3022 | | |
| OFA-Modified | 2 | 3454 | 3800 | 5436 |
| Binder | 4 | 3363 | 3500 | 3786 |
| | 6 | 3225 | 3434 | 3547 |
| | 8 | 3280 | 3461 | 3274 |
| OFA-Replaced | 1 | 2997 | 4012 | 3915 |
| Filler | 2 | 2271 | 3800 | 2550 |
| | 3 | 1014 | 3233 | 2305 |

As shown in Table 5, the resilient modulus (M_{R}) of OFA-COOH and OFA-C₁₈ modified blends is greater than that of an untreated OFA mix. Based on the ITS test results shown in Table 3 and the resilient modulus test results shown in Table 4, optimum blends were selected for further performance testing to explore their permanent deformation behavior and their fatigue. The optimum OFA content was 2% for binder modified mixes and 1% for filler replacement mixes.

Referring to FIG. 1, a chart 100 of experimental measurements of rutting test results is shown. The rutting test was performed to determine the permanent deformation behavior of the optimum OFA content selected from the ITS and resilient modulus testing. Plain and modified asphalt mixes were evaluated for rutting resistance using an asphalt pavement analyzer (APA) according to AASHTO TP 63-06 specifications at a test temperature of about 64° C. Test samples were conditioned at the test temperature for about 4 hours. Wheel load was set to 100 lb, and wheel pressure was set to 100 psi. Test samples of 15 cm (6 inches) were compacted to an improved density using a gyratory compactor. FIG. 1 shows that plain asphalt concrete mix had the highest rutting amount of 6.5 mm at 8000 load repetitions. Asphalt concrete mixes with 2% OFA-COOH modified binder mix gave the least rutting amount of 2.23 mm at 8000 load repetitions. Concrete mixes with 2% OFA-C₁₈ modified binder gave rutting of 2.6 mm at 8000 load repetitions.

Referring to FIG. 2, a chart 200 of experimental measurements of a flexural fatigue test is shown. The flexural fatigue test was performed according to AASHTO T-321 (TP8-94) guidelines to test for fatigue properties of prepared asphalt concrete beam samples. The samples were tested in a stress-controlled mode to simulate asphalt pavement thick layer construction used locally in Saudi Arabia. Several samples were tested under different bending peak-to-peak stresses (kPa) and corresponding peak-to-peak strains (×10⁻⁶) were calculated. Asphalt concrete slabs having dimensions of 38 cm×30 cm×6.6 cm were compacted to the density of optimum asphalt mixes using a slab compactor. Slabs were cut into beam samples having dimensions of 38 cm×6.6 cm×5.0 cm using a masonry saw. Fatigue testing was performed at a testing temperature of 25° C. and at an applied tensile strain of about 200 micro strain. Beam samples were conditioned at the testing temperature of 25° C. and tested for flexural fatigue. As the asphalt concrete beam sample was subjected to load repetitions, stiffness decreased rapidly in the beginning and then reached a constant slope until failure of the beam, which was defined as 40% of initial stiffness. The collected data was analyzed to determine the relationship between load repetition to failure (N) and applied peak-to-peak stress (a) or initial peak-to-peak strain (c). Results indicate that 2% OFA-COOH-modified binder mix had the highest fatigue life of 1,961,039, followed by 2% OFA-C₁₈-modified binder mix with a fatigue life of 1,729,595. Plain asphalt concrete mix had the lowest fatigue life of 544,235. Therefore, asphalt concrete with 2% OFA-COOH modified binder mix will generally have a greater life span in comparison to plain asphalt concrete.

Thus, the asphalt with modified oil fly ash additive improved the performance grade of asphalt binder from 64-10 to 82-10, eliminated the need for the usual commercial polymer modifier, improved the rutting resistance of asphalt concrete mixes over unmodified oil fly ash, and provides for an environmentally friendly way of disposing of oil fly ash waste.

It is to be understood that the present invention is not limited to the embodiments described above, but encompasses any and all embodiments within the scope of the following claims.

We claim:

1. An asphalt binder, comprising:
asphalt cement; and
modified oil fly ash mixed with the asphalt cement, the modified oil fly ash being particles of oil fly ash having a functional group attached thereto selected from the group consisting of a carboxylic acid group (—COOH) and a 1-octadecanoate group.

2. The asphalt binder according to claim 1, wherein the functional group attached to the oil fly ash is a carboxylic acid group.

3. The asphalt binder according to claim 1, wherein the functional group attached to the oil fly ash is 1-octadecanoate.

4. The asphalt binder according to claim 1, wherein the modified oil fly ash comprises between 2% and 8% of the total mass of the mixture of asphalt cement and modified oil fly ash.

5. The asphalt binder according to claim 1, wherein the modified oil fly ash comprises about 8% of the total mass of the mixture of asphalt cement and modified oil fly ash, the asphalt binder having a performance grade of about 82-10.

6. An asphalt concrete mix, comprising a mixture of:
asphalt;
aggregate; and
modified oil fly ash, the modified oil fly ash being particles of oil fly ash having a functional group attached thereto selected from the group consisting of a carboxylic acid group (—COOH) and a 1-octadecanoate group.

7. The asphalt concrete mix according to claim 6, wherein the functional group attached to the oil fly ash is a carboxylic acid group.

8. The asphalt concrete mix according to claim 6, wherein the functional group attached to the oil fly ash is 1-octadecanoate.

9. The asphalt concrete mix according to claim 6, wherein the modified oil fly ash is mixed with the asphalt to form an asphalt binder, the binder being mixed with the aggregate.

10. The asphalt concrete mix according to claim 9, wherein the modified oil fly ash comprises about 2% of the total mass of the binder.

11. The asphalt concrete mix according to claim 6, wherein the modified oil fly ash is a filler mixed with the aggregate to form an aggregate/filler mixture, the asphalt being mixed with the aggregate/filler mixture.

12. The asphalt concrete mix according to claim 11, wherein the modified oil fly ash comprise about 1% of the total mass of the aggregate/filler mixture.

13. The asphalt concrete mix according to claim 6, wherein the aggregate comprises about 95% of the total mass of the asphalt concrete mix.

14. A modified oil fly ash, comprising particles of oil fly ash having a 1-octadecanoate group attached thereto.
